(19) United States
(12) Patent Application Publication
(10) Pub. No.: US 2008/0040288 A1
(43) Pub. Date: Feb. 14, 2008

(54) Method and system for using RSS-Type feeds in an E-Commerce environment

(75) Inventors: William Charles Mortimore, San Francisco, CA (US); Matthew Mihic, San Francisco, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: REARDEN COMMERCE, INC.

(21) Appl. No.: 11/484,134

(22) Filed: Jul. 10, 2006

(51) Int. Cl. H04L 9/00

(52) U.S. Cl. 705/75

(57) ABSTRACT

A method for using RSS-Type feeds in an E-Commerce environment, is described. In one embodiment, the method is to be implemented on a system. In one embodiment the method comprises a service portal receiving multiple notifications from separate service providers, the notifications including a universal resource locators (URLs) corresponding to a service provider providing the notifications, the notifications being sent to addressees from the respective service providers; generating a amended URL for the notifications to have the respective addressees access the notifications via the service portal; and the service portal providing to the notifications having the amended URLs to addressees.

### BACKGROUND OF THE INVENTION

E-commerce environments allow providers of goods and services to make electronic transactions, such as purchases, sales, etc. More recently, electronic service portals are consolidating many different providers into one service portal, allowing that service portal to offer services and transactions of various kinds. However, if a user of such a portal has subscribed to a service provider's web site information services, there may be, for example, a disconnect between the URLs for the information he receives directly from the provider and the URLs that let him access this information on the service portal.

What is clearly needed is a system and method for consolidating and rebroadcasting information with updated URLs that lead to the correct service site of the aggregator or service portal and the sub-page of that service provider.

### SUMMARY

A method for using RSS-Type feeds in an E-Commerce environment, is described. In one embodiment, the method is to be implemented on a system. In one embodiment the method comprises a service portal receiving multiple notifications from separate service providers, the notifications including a universal resource locators (URLs) corresponding to a service provider providing the notifications, the notifications being sent to addressees from the respective service providers; generating a amended URL for the notifications to have the respective addressees access the notifications via the service portal; and the service portal providing to the notifications having the amended URLs to addressees.

### BRIEF DESCRIPTION OF FIGURES

FIG. 1 shows an overview of a system according to one embodiment; and

FIG. 2 shows an exemplary process flow in accordance with one embodiment.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

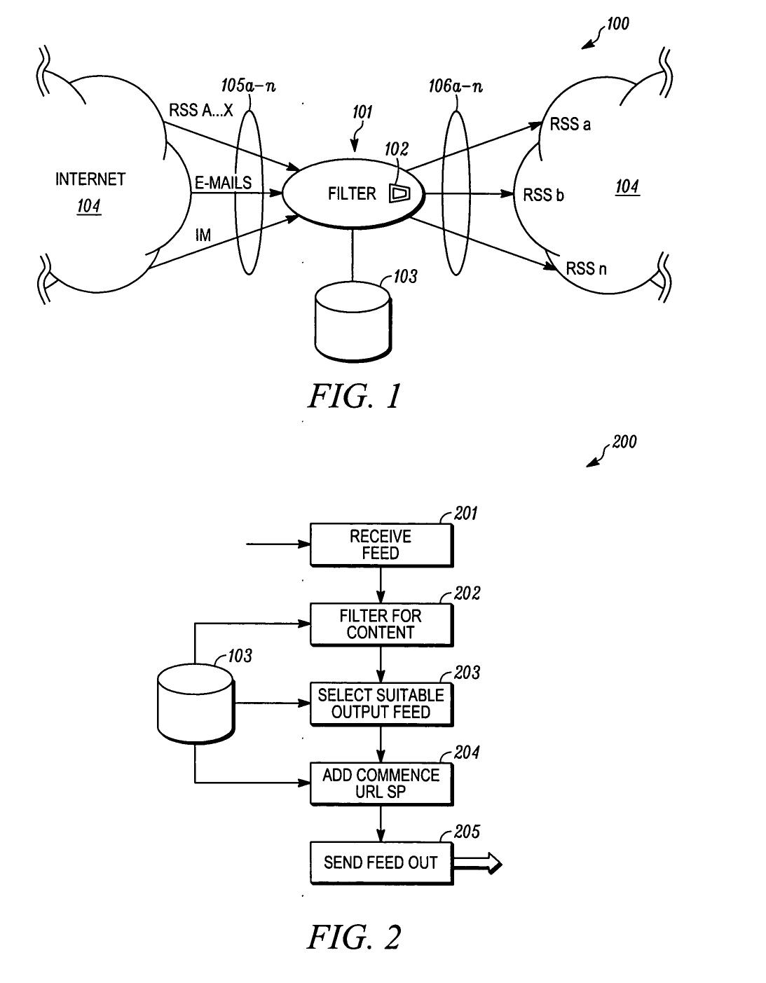

FIG. 1 shows an overview of a system 100 according to the current invention. The main operating structure 101 is a filtering or re-syndication system running on a server 102 and using a database 103 as its main operational database. Typically this structure 101 could be integrated with a services portal or other suitable applications, but in some cases it may be operated separately. Also shown is the Internet 104. Structure 101 receives various messages or content notifications, in the form of resource description framework (RDF), site or page summaries as Real Simple Syndication (RSS) feeds RSS_{1 . . . x}, Atom feeds, emails, instant messages (IMs), SMSes, etc., all as input streams or notification streams 105a-n, via said Internet 104. On the other side, re-targeted content and notifications are delivered as subscription feeds such as RSSₐ₋ₙ, or Atom feeds, emails, instant messages (IMs), SMSes, etc., all as output streams 106a-n via Internet 104. It is clear that RSS, email, or IM should not be considered a limiting description of input streams 105a-n or output streams 106a-n, but instead just an exemplary type of feed or stream that may be used. Any other similar or equivalent types of feed or electronic media may be used without departing from novel art of this invention.

FIG. 2 shows an exemplary process flow 200 of the system 100 according to the current invention. An input feed, such as a publication, is received by a service portal in step 201 from one of the input streams 105a-n. The publications, which in one embodiment are a notification or offer, are addressed to addressees. The publications include a URL corresponding to the service provider that has provided the publication. In one embodiment, the service provider may provide products in addition to, or in place of services.

The received publication is then filtered for applicable content in step 202, using, for example, main database 103 as storage for the filters

In step 203, based on the type, scope, and applicability of a notification or offer, it is assigned to one or more output feeds 106a-n. In step 204, a URL for the service portal is calculated or retrieved, in accordance with the particular service provider. In one embodiment, based on the service provider's related offerings and or available URLs, the service type, etc., and that URL is added to the publication item, which may be an RSS or any of various other types of data transmission as are well known in the art, some of which have been previously listed. Said message or notification with the URL is then sent out in step 205.

It is clear that many modifications and variations of this invention may be made by one skilled in the art without departing from the spirit of the novel art of this disclosure. For example, a user may wish to include in his profiles a credit card for his college-age child, in which case the person in the profile would be, for example, Susan Doe, while the credit card and address details would be the same.

At least some embodiments, and the different structure and functional elements described herein, can be implemented using hardware, firmware, programs of instruction, or combinations of hardware, firmware, and programs of instructions.

In general, routines executed to implement the embodiments can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions can be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Some aspects can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache, magnetic and optical disks, or a remote storage device. Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), or firmware such as electrically erasable programmable read-only memory (EEPROM's).

In various embodiments, hardwired circuitry can be used in combination with software instructions to implement the embodiments. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent can be reordered and other operations can be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications can be made thereto without departing from the broader spirit and scope of the invention as set forth in the following claims. The specification and drawings are, accordingly, to be regarded in an illustrative sense rather than a restrictive sense.

What is claimed is:

1) A method comprising: A service portal receiving multiple notifications from separate service providers, the notifications including a universal resource locators (URLs) corresponding to a service provider providing the notifications, the notifications being sent to addressees from the respective service providers;
Generating a amended URL for the notifications to have the respective addressees access the notifications via the service portal; and
The service portal providing to the notifications having the amended URLs to addressees.

2) The method of claim 1, wherein the notification item includes one or more of an offer or publication from one of the plurality of service providers.

3) The method of claim 2, wherein the notification is received as one of a resource description framework (RDF), Real Simple Syndication (RSS) feeds, Atom feeds, emails, instant messages (IMs), or SMS's.

4) The method of claim 3, wherein the notification is provided to the addressees by the service portal as one of a resource description framework (RDF), Real Simple Syndication (RSS) feeds, Atom feeds, emails, instant messages (IMs), or SMS's

5) A machine readable medium having stored thereon a set of instructions which when executed perform a method comprising:
A service portal receiving multiple notifications from separate service providers, the notifications including a universal resource locators (URLs) corresponding to a service provider providing the notifications, the notifications being sent to addressees from the respective service providers;
Generating a amended URL for the notifications to have the respective addressees access the notifications via the service portal; and
The service portal providing to the notifications having the amended URLs to addressees.

6) The machine readable medium of claim 5, wherein the notification item includes one or more of an offer or publication from one of the plurality of service providers.

7) The machine readable medium of claim 6, wherein the notification is received as one of a resource description framework (RDF), Real Simple Syndication (RSS) feeds, Atom feeds, emails, instant messages (IMs), or SMS's.

8) The machine readable medium of claim 7, wherein the notification is provided to the addressees by the service portal as one of a resource description framework (RDF), Real Simple Syndication (RSS) feeds, Atom feeds, emails, instant messages (IMs), or SMS's.

9) A system comprising:
A means for a service portal receiving multiple notifications from separate service providers, the notifications including a universal resource locators (URLs) corresponding to a service provider providing the notifications, the notifications being sent to addressees from the respective service providers;
A means for generating a amended URL for the notifications to have the respective addressees access the notifications via the service portal; and
A means for the service portal providing to the notifications having the amended URLs to addressees.

10) The system of claim 9, wherein the notification item includes one or more of an offer or publication from one of the plurality of service providers.

11) The system of claim 6, wherein the means for receiving includes means for receiving the notification as one of a resource description framework (RDF), Real Simple Syndication (RSS) feeds, Atom feeds, emails, instant messages (IMs), or SMS's.

12) The system of claim 7, wherein the means for providing includes means for providing the notification to the addressees by the service portal as one of a resource description framework (RDF), Real Simple Syndication (RSS) feeds, Atom feeds, emails, instant messages (IMs), or SMS's.
